(19) United States
(12) Patent Application Publication
(10) Pub. No.: US 2026/0147014 A1
(43) Pub. Date: May 28, 2026

(54) SCANNING AND MICRO-MASS IMAGING TECHNOLOGY USING PROBE

(71) Applicant: Nanchang Hangkong University, Nanchang City (CN)

(72) Inventors: Weiqing Liu, Nanchang City (CN); Ying Liu, Nanchang City (CN); Ligang Yuan, Nanchang City (CN); Wenhao Chen, Nanchang City (CN); Junhong Duan, Nanchang City (CN)

(73) Assignee: Nanchang Hangkong University, Nanchang City (CN)

(21) Appl. No.: 19/373,293

(22) Filed: Oct. 29, 2025

(30) Foreign Application Priority Data
Nov. 28, 2024 (CN) 202411722723.2

(51) Int. Cl. G01Q 60/42; G01Q 60/40; G01Q 70/14

(52) U.S. Cl. CPC G01Q 60/42; G01Q 60/40; G01Q 70/14

(57) ABSTRACT

Disclosed is a scanning and micro-mass imaging technology using a probe. The technology includes a probe, a probe moving module, an optical microscopic measurement module, an oscillation excitation module, a probe position measurement module, a quartz crystal oscillator, an oscillation signal collection module, a speed-sensitive switch, an integration cell, a software processing module, and a sample. The probe is placed perpendicularly, a top end of the probe has a dual-electrode mode of an electrode S1 and an electrode S2, and the quartz crystal oscillator is coated with the sample. The probe performs multi-point, line and surface scanning to detect properties such as a micro-mass and viscoelasticity of the sample, such that distributions of micro-mass and viscoelasticity changes can be obtained in situ, and reaction mechanisms in different regions can be obtained.

### REFERENCE TO PRIOR APPLICATION

This application claims priority to Chinese Patent Application 202411722723.2, filed on Nov. 28, 2024, which is incorporated herein by reference.

### TECHNICAL FIELD

The present disclosure relates to the technical field of imaging with probes, and particularly relates to a scanning and micro-mass imaging technology using a probe.

### BACKGROUND

A probe microscope, a surface analysis tool, obtains surface information of a sample through interaction between a probe and a surface of the sample. For instance, a scanning tunneling microscope performs imaging by measuring a tunneling current between a probe and a sample. An atomic force microscope performs imaging by measuring a van der Waals force between a probe and a sample. A Kelvin probe force microscope performs imaging by measuring a Kelvin contact potential difference between a probe and a sample. A magnetic force microscope performs imaging through magnetic interaction between a probe and a sample. A near-field optical scanning microscope performs imaging through a near-field optical effect. A scanning electrochemistry microscope performs imaging through electrochemistry information between a probe and a sample. A thermal field scanning microscope performs imaging by measuring thermal interaction between a probe and a sample. These probe microscopes are widely used in physics, chemistry, biology, materials science, microelectronics, and other fields.

In a physical or chemical process, masses of materials may change. For instance, solidification, evaporation, condensation, sublimation, desublimation, adsorption, dissolution, synthesis reaction, decomposition reaction, displacement reaction, redox reaction or other processes of a material can all cause an increase, a decrease or invariability of a micro-mass of a surface of the material, or cause viscoelasticity changes of the material. By obtaining and analyzing micro-mass and viscoelasticity change information, a physical and chemical process mechanism of substances can be inferred.

Obtainment of surface micro-mass and viscoelasticity distribution information can enrich an analysis process, and further reveal mechanisms, not fully understood in physical and chemical processes, of materials, which facilitates deeper understanding of complexity of material changes in scientific research. However, according to results of literature research, there is no research and reports on such imaging technology with a probe.

Quartz crystals have piezoelectric properties. That is, when the quartz crystals are subjected to mechanical pressure, a charge center of their internal lattice can shift, resulting in polarization. On the contrary, if electric fields are applied to two electrodes of a quartz crystal, a wafer will be mechanically deformed, which is referred to as an inverse piezoelectric effect. When an alternating electromagnetic field is applied to a surface of the quartz crystal, the wafer can generate mechanical oscillation with a certain resonance frequency. When the surface of the quartz crystal adsorbs or desorbs substances, the mass change can lead to a change of the resonance frequency of the wafer. By measuring the change of resonance frequency, a micro-mass change and a viscoelasticity change on a surface of the wafer can be accurately detected. A quartz crystal microbalance technology produced by this principle can achieve measurement accuracy of a nanogram level. A mass change that can be measured theoretically is equivalent to a fraction of that of a monolayer or an atomic layer. This kind of micro-mass sensor has a simple structure, low cost and high sensitivity, and is widely used in chemical and biological fields.

However, existing technologies can only obtain macroscopic and average information of surface mass changes. They can neither obtain multiple information such as mass changes and uneven distributions in a region, nor directly express the information through imaging.

The present disclosure provides a scanning and micro-mass imaging technology using a probe. It uses very small electrodes (probes) to excite a quartz crystal oscillator loaded with a sample at a plurality of points to obtain a dot matrix micro-mass distribution, and obtains visual image information of micro-mass changes through a computer and other auxiliary apparatuses.

### SUMMARY

An objective of the present disclosure is to solve technical problems existing in the prior art, and provide a scanning and micro-mass imaging technology using a probe.

To achieve the objective, the present disclosure provides the technical solution as follows: The scanning and micro-mass imaging technology using a probe includes a probe, a probe moving module, an optical microscopic measurement module, an oscillation excitation module, a probe position measurement module, a quartz crystal oscillator, an oscillation signal collection module, a speed-sensitive switch, an integration cell, a software processing module, and a sample. The probe is placed perpendicularly, and a top end of the probe has a dual-electrode mode of an electrode S1 and an electrode S2. The quartz crystal oscillator is coated with the sample.

The probe is used for generating an electromagnetic field signal for excitation of micro-region oscillation of the quartz crystal oscillator and receiving an electromagnetic field signal for oscillation attenuation of the quartz crystal oscillator.

The probe moving module is capable of moving in three directions of x, y and z axes.

The optical microscopic measurement module is used for measuring a perpendicular distance between the probe and the quartz crystal oscillator.

The oscillation excitation module is used for sending a high-frequency oscillation signal to excite micro-region oscillation of the quartz crystal oscillator through the probe.

The probe position measurement module is used for measuring dot matrix coordinate information of a position of the probe.

The speed-sensitive switch is used for quickly shutting off an excitation signal of the oscillation excitation module.

The oscillation signal collection module is used for collecting an oscillation amplitude and frequency of the quartz crystal oscillator.

The integration cell is one of a gaseous phase cell, a liquid phase cell, an electrochemistry cell, and a photo-electrochemistry cell, and is used for providing a reaction environment for changes of a micro-mass Δm and viscoelasticity ΔQ of the sample.

The software processing module is embedded with an envelope fitting equation, an underdamped equation, and a Sauerbrey equation for operation, and obtains Δmxiyj and ΔQxiyj information of an i×j dot matrix, where i denotes a quantity of test points in the direction of the x axis, and j denotes a quantity of test lines in the direction of the y axis; and further performs processing to obtain distribution images of the micro-mass and a dissipation factor of the sample on a surface of the quartz crystal oscillator.

Preferably, the oscillation excitation module sends the high-frequency oscillation signal having an identical frequency to a fundamental frequency f0 of the quartz crystal oscillator to the probe. When the probe gradually approaches the quartz crystal oscillator along the z axis, the optical microscopic measurement module displays and measures relative positions of the probe and the quartz crystal oscillator. When the probe makes contact with the quartz crystal oscillator, the probe moving module stops the probe from approaching. Meanwhile, the electrode S1 and the electrode S2 at the top end of the probe convert a signal sent by the oscillation excitation module into the electromagnetic field signal for excitation of the micro-region oscillation of the quartz crystal oscillator, and the oscillation signal collection module collects the oscillation amplitude and frequency of the quartz crystal oscillator coated with the sample currently. The probe position measurement module obtains a current coordinate position (xi, yj).

After the micro-region oscillation of the quartz crystal oscillator is stable, the speed-sensitive switch quickly shuts off the excitation signal of the oscillation excitation module. Meanwhile, an oscillation process of the quartz crystal oscillator presents an electromagnetic field signal for underdamped attenuation, and the electrode S1 and the electrode S2 at the top end of the probe are used as reception electrodes of an electromagnetic field to receive attenuation signals. The oscillation signal collection module collects the attenuation signals at a sampling rate not lower than 2 times of the fundamental frequency f0, and the steps are repeated by moving the probe in x and y planes to obtain the Δmxiyj and ΔQxiyj information of the i×j dot matrix. The software processing module performs processing to obtain distribution images of micro-mass and viscoelasticity changes of the sample on the surface of the quartz crystal oscillator.

Preferably, when the integration cell is the gaseous phase cell, the quartz crystal oscillator coated with the sample is mounted at a bottom of the gaseous phase cell. The gaseous phase cell is provided with a first connector and a second connector. Research gas is guided into the gaseous phase cell through the first connector. The research gas reacts with the sample to cause micro-mass and viscoelasticity changes. Finally, the gas is discharged from the second connector.

Preferably, when the integration cell is the liquid phase cell, the quartz crystal oscillator coated with the sample is mounted at a bottom of the liquid phase cell. The liquid phase cell is provided with a first connector and a second connector. Liquid is guided into the liquid phase cell through the first connector. The liquid reacts with the sample to cause micro-mass changes. Finally, the liquid is discharged from the second connector.

Preferably, when the integration cell is the electrochemistry cell, a transparent conductive oxide film is deposited on the surface of the quartz crystal oscillator, and the quartz crystal oscillator is mounted at a bottom of the electrochemistry cell. The sample is deposited on the quartz crystal oscillator in advance or deposited on the quartz crystal oscillator in a photo-electrochemistry reaction process. A three-electrode system is arranged in the electrochemistry cell. The three-electrode system is connected to an external electrochemistry workstation.

Preferably, when the integration cell is the photo-electrochemistry cell, a transparent conductive oxide film is deposited on the surface of the quartz crystal oscillator, and the quartz crystal oscillator is mounted at a bottom of the photo-electrochemistry cell. The sample is deposited on the quartz crystal oscillator in advance or deposited on the quartz crystal oscillator in an electrochemistry reaction process. A three-electrode system is arranged in the photo-electrochemistry cell. The three-electrode system is connected to an external electrochemistry workstation. An external spectrum tester emits a light beam that irradiates the sample, and meanwhile, receives and analyzes a light beam reflected/transmitted by the sample.

Preferably, a working electrode in the three-electrode system is the quartz crystal oscillator or the sample deposited on the surface of the quartz crystal oscillator. A counter electrode in the three-electrode system is one of electrodes of noble metals such as gold, silver, platinum, palladium and iridium, and alloys of the metals. A reference electrode in the three-electrode system is one of a hydrogen electrode, a calomel electrode, a silver-silver chloride electrode, a mercury-mercuric oxide electrode, and a mercury-mercurous sulfate electrode. The transparent conductive oxide film is one of an indium tin oxide film, an aluminum-doped zinc oxide film, a fluorine-doped tin oxide film, an antimony-doped tin oxide film, a gallium-doped zinc oxide film, zinc oxide films doped with other elements, and a titanium oxide-based film.

Preferably, the electrode S1 and the electrode S2 are coils or metal sheets. The quartz crystal oscillator is a thin quartz sheet having a piezoelectric property.

The present disclosure has beneficial effects:

The scanning and micro-mass imaging technology using a probe in the present disclosure is a non-invasive nondestructive testing technology, and does not influence a reaction system. Multi-point, line and surface scanning may be performed to detect properties such as a micro-mass and viscoelasticity of the sample, such that distributions of the micro-mass and viscoelasticity changes can be obtained in situ, and reaction mechanisms in different regions can be obtained. By combining various technical means, the technology can obtain more reaction process information, and can be widely applied to research of film deposition monitoring, electrochemistry electrode processes, surface electrochemistry and catalytic electrochemistry, environmental monitoring, drug and biomolecule testing, etc.

### BRIEF DESCRIPTION OF DRAWINGS

The accompanying drawings, used to provide further understanding of the present disclosure, constitute part of the present disclosure, and illustrative examples of the present disclosure and their description serve to explain the present disclosure and are not to be construed as unduly limiting the present disclosure.

FIG. 1 is a schematic diagram of an overall structure of the present disclosure.

FIG. 2 is a structural diagram of a top end of a probe of the present disclosure.

FIG. 3 is a schematic diagram of an electrochemistry cell of the present disclosure.

FIG. 4 is a schematic diagram of a photo-electrochemistry cell of the present disclosure.

FIG. 5 is a dot matrix image of a micro-mass and viscoelasticity of an i×j dot matrix of the present disclosure.

### REFERENCE NUMBERS

1—probe, 2—probe moving module, 3—optical microscopic measurement module, 4—oscillation excitation module, 5—probe position measurement module, 6—quartz crystal oscillator, 7—oscillation signal collection module, 8—speed-sensitive switch, 9—integration cell, 10—software processing module, 11—sample, 12—first connector, 13—second connector, 14—electrochemistry cell, 15—transparent conductive oxide film, 16—counter electrode, 17—reference electrode, 18—electrochemistry workstation, 19—spectrum tester.

### DETAILED DESCRIPTION OF EMBODIMENTS

This part will describe specific examples of the present disclosure in detail. Preferred examples of the present disclosure are shown in accompanying drawings. The accompanying drawings are used for supplementing description of a text part of the description with graphics, such that people can intuitively and vividly understand all technical features and an overall technical solution of the present disclosure. However, the drawings cannot be understood as limiting the protection scope of the present disclosure.

The present disclosure provides a scanning and micro-mass imaging technology using a probe. It uses very small electrodes (probes) to excite a quartz crystal oscillator loaded with a sample at a plurality of points to obtain a dot matrix micro-mass and viscoelasticity distribution, and obtains visual image information of micro-mass and viscoelasticity changes through a computer and other auxiliary apparatuses.

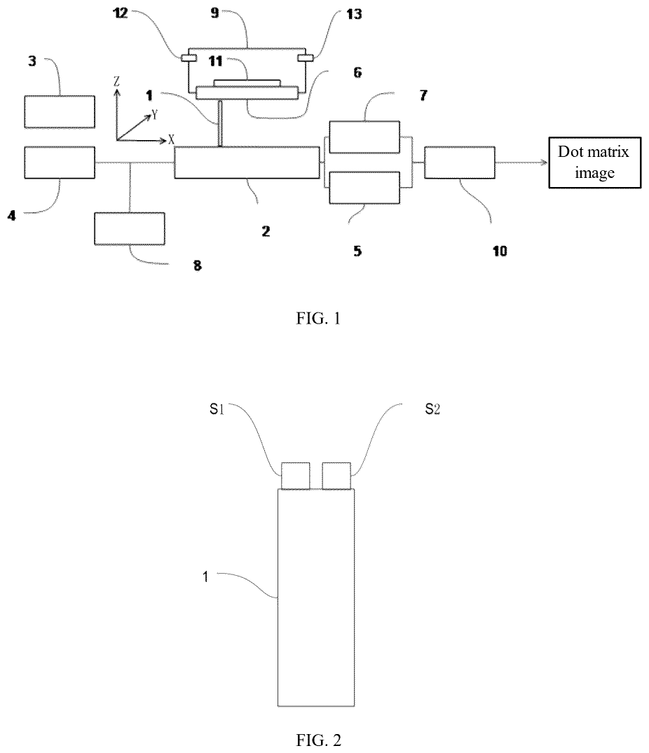

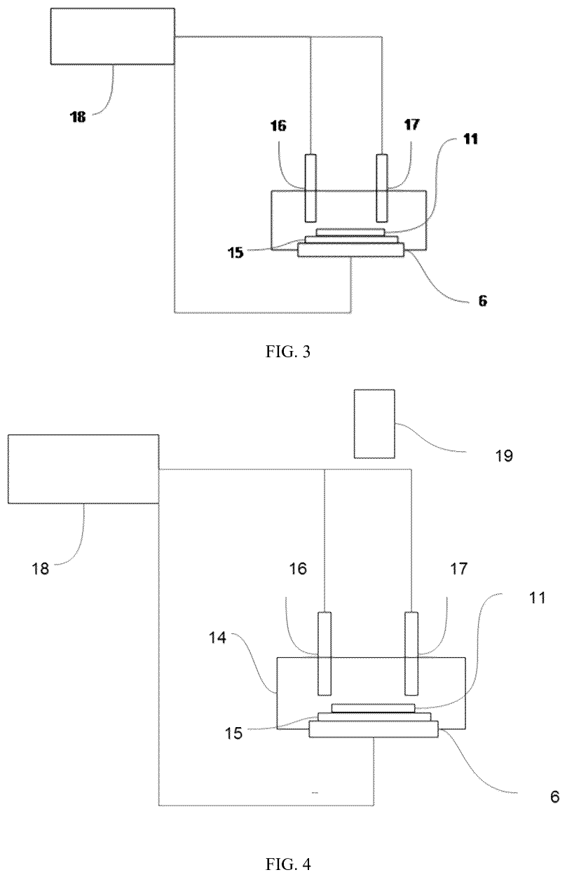

With reference to FIG. 1 to FIG. 5, in a preferred example of the present disclosure, a scanning and micro-mass imaging technology using a probe includes a probe 1, a probe moving module 2, an optical microscopic measurement module 3, an oscillation excitation module 4, a probe position measurement module 5, a quartz crystal oscillator 6, an oscillation signal collection module 7, a speed-sensitive switch 8, an integration cell 9, a software processing module 10, and a sample 11. The probe 1 is placed perpendicularly, and a top end of the probe has a dual-electrode mode of an electrode S1 and an electrode S2. The quartz crystal oscillator 6 is coated with the sample 11. The electrode S1 and the electrode S2 are coils or metal sheets. The quartz crystal oscillator 6 is a thin quartz sheet having a piezoelectric property.

The probe 1 is used for generating an electromagnetic field signal for excitation of micro-region oscillation of the quartz crystal oscillator 6 and receiving an electromagnetic field signal for oscillation attenuation of the quartz crystal oscillator 6.

The probe moving module 2 is capable of moving in three directions of x, y and z axes.

The optical microscopic measurement module 3 is used for measuring a perpendicular distance between the probe 1 and the quartz crystal oscillator 6.

The oscillation excitation module 4 is used for sending a high-frequency oscillation signal to excite micro-region oscillation of the quartz crystal oscillator 6 through the probe 1.

The probe position measurement module 5 is used for measuring dot matrix coordinate information of a position of the probe 1.

The speed-sensitive switch 8 is used for quickly shutting off an excitation signal of the oscillation excitation module 4.

The oscillation signal collection module 7 is used for collecting an oscillation amplitude and frequency of the quartz crystal oscillator 6.

The integration cell 9 is one of a gaseous phase cell, a liquid phase cell, an electrochemistry cell 14, and a photo-electrochemistry cell, and is used for providing a reaction environment for changes of a micro-mass Δm and viscoelasticity ΔQ of the sample 11.

The software processing module 10 is embedded with an envelope fitting equation, an underdamped equation, and a Sauerbrey equation for operation, and obtains Δmxiyj and ΔQxiyj information of an i×j dot matrix, where i denotes a quantity of test points in the direction of the x axis, and j denotes a quantity of test lines in the direction of the y axis; and further performs processing to obtain distribution images of the micro-mass and a dissipation factor of the sample 11 on a surface of the quartz crystal oscillator 6.

### EXAMPLE 1

When the integration cell 9 is the gaseous phase cell, the quartz crystal oscillator 6 coated with the sample 11 is mounted at a bottom of the gaseous phase cell. The gaseous phase cell is provided with a first connector 12 and a second connector 13. Research gas is guided into the gaseous phase cell through the first connector 12. The research gas reacts with the sample 11 to cause micro-mass changes. Finally, the gas is discharged from the second connector 13.

In the example, the oscillation excitation module 4 sends the high-frequency oscillation signal having an identical frequency to a fundamental frequency f0 of the quartz crystal oscillator 6 to the probe 1. When the probe 1 gradually approaches the quartz crystal oscillator 6 along the z axis, the optical microscopic measurement module 3 displays and measures relative positions of the probe 1 and the quartz crystal oscillator 6. When the probe 1 makes contact with the quartz crystal oscillator 6, the probe moving module 2 stops the probe 1 from approaching. Meanwhile, the electrode S1 and the electrode S2 at the top end of the probe 1 convert a signal sent by the oscillation excitation module 4 into the electromagnetic field signal for excitation of the micro-region oscillation of the quartz crystal oscillator 6. The oscillation signal collection module 7 collects the oscillation amplitude and frequency of the quartz crystal oscillator 6 coated with the sample 11 currently. The probe position measurement module 5 obtains a current coordinate position (xi, yj).

After the micro-region oscillation of the quartz crystal oscillator 6 is stable, the speed-sensitive switch 8 quickly shuts off the excitation signal of the oscillation excitation module 4. Meanwhile, an oscillation process of the quartz crystal oscillator 6 presents an electromagnetic field signal for underdamped attenuation, and the electrode S1 and the electrode S2 at the top end of the probe 1 are used as reception electrodes of an electromagnetic field to receive attenuation signals. The oscillation signal collection module 7 collects the attenuation signals at a sampling rate not lower than 2 times of the fundamental frequency f0. An attenuation time constant tx1y1 is obtained by embedding the envelope fitting equation in the software processing module 10, and a frequency fx1y1 is obtained through the underdamped equation. Through Δfx1y1=f0−fx1y1, a micro-region change frequency Δfx1y1 is obtained. Then, through the Sauerbrey equation, Δfx1y1 is converted into a micro-mass change Δmx1y1 of the sample 11. Through ΔQx1y1=tx1y1×fx1y1, a dissipation factor ΔQx1y1 of a micro-region viscoelasticity change is obtained. The probe 1 is moved to a next position (x2, y1) through the probe moving module 2, and Δmx2y1 is obtained by repeating the above steps.

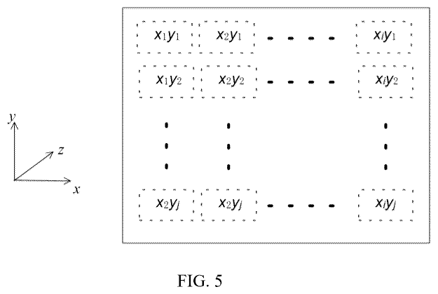

By analogy, Δmxiy1 and ΔQxiy1 of line y1 are obtained separately (i denotes the quantity of test points in the direction of the x axis), and yj is changed (j denotes the quantity of test lines in the direction of the y axis). Finally, the Δmxiyj and ΔQxiyj information of the i×j dot matrix as shown in FIG. 5 is obtained, and i and j dot matrices are formed. The software processing module 10 further performs processing to obtain the distribution images of the micro-mass and viscoelasticity changes of the sample 11 in a region on the surface of the quartz crystal oscillator 6.

### EXAMPLE 2

When the integration cell 9 is the liquid phase cell, the quartz crystal oscillator 6 coated with the sample 11 is mounted at a bottom of the liquid phase cell. The liquid phase cell is provided with a first connector 12 and a second connector 13. Liquid is guided into the liquid phase cell through the first connector 12. The liquid reacts with the sample 11 to cause micro-mass changes. Finally, the liquid is discharged from the second connector 13. The micro-mass imaging step is identical to that in Example 1.

### EXAMPLE 3

When the integration cell 9 is the photo-electrochemistry or electrochemistry cell, the quartz crystal oscillator 6 with the surface on which a transparent conductive oxide film 15 is deposited is mounted at a bottom of the photo-electrochemistry or electrochemistry cell. The sample 11 may be deposited on the quartz crystal oscillator 6 in advance or deposited on the quartz crystal oscillator 6 in a photo-electrochemistry or electrochemistry reaction process. A three-electrode system is arranged in the photo-electrochemistry or electrochemistry cell. The three-electrode system is connected to an external electrochemistry workstation 18. An external spectrum tester 19 may emit a light beam that irradiates the sample 11, and meanwhile, receives and analyzes a light beam reflected/transmitted by the sample 11.

### EXAMPLE 4

When the integration cell 9 is the electrochemistry cell 14, a transparent conductive oxide film 15 is deposited on the surface of the quartz crystal oscillator 6, and the quartz crystal oscillator is mounted at a bottom of the electrochemistry cell. The sample 11 is deposited on the quartz crystal oscillator 6 in advance or deposited on the quartz crystal oscillator 6 in an electrochemistry reaction process. A three-electrode system is arranged in the electrochemistry cell 14. The three-electrode system is connected to an external electrochemistry workstation 18.

Further, a working electrode in the three-electrode system is the quartz crystal oscillator 6 or the sample 11 deposited on the surface of the quartz crystal oscillator 6. A counter electrode 16 in the three-electrode system is one of electrodes of noble metals such as gold, silver, platinum, palladium and iridium, and alloys of the metals. A reference electrode 17 in the three-electrode system is one of a hydrogen electrode, a calomel electrode, a silver-silver chloride electrode, a mercury-mercuric oxide electrode, and a mercury-mercurous sulfate electrode. The transparent conductive oxide film 15 is one of an indium tin oxide (ITO) film, an aluminum-doped zinc oxide (AZO) film, a fluorine-doped tin oxide (FTO) film, an antimony-doped tin oxide (ATO) film, a gallium-doped zinc oxide (GZO) film, zinc oxide (ZnO) films doped with other elements, and a titanium oxide (TiO2)-based film.

Further, the micro-mass imaging step when the integration cell 9 is the electrochemistry cell 14 and the photo-electrochemistry cell is different from Example 2 in that an imaging process is synchronized with an electrochemistry process under the control of the electrochemistry workstation 18. The other principles and steps are identical to those in Example 1.

The scanning and micro-mass imaging technology using a probe in the present disclosure is a non-invasive nondestructive testing technology, and does not influence a reaction system. Multi-point, line and surface scanning may be performed to detect properties such as a micro-mass and viscoelasticity of the sample, such that distributions of the micro-mass and viscoelasticity changes can be obtained in situ, and reaction mechanisms in different regions can be obtained. By combining various technical means, the technology can obtain more reaction process information, and can be widely applied to research of film deposition monitoring, electrochemistry electrode processes, surface electrochemistry and catalytic electrochemistry, environmental monitoring, drug and biomolecule testing, etc.

On the premise of no conflict, those skilled in the art can freely combine and use the above additional technical features.

What are described above are only preferred embodiments of the present disclosure, and all technical solutions that achieve the objective of the present disclosure by basically identical means fall within the protection scope of the present disclosure.

What is claimed is:

1. A scanning and micro-mass imaging technology using a probe, comprising a probe, a probe moving module, an optical microscopic measurement module, an oscillation excitation module, a probe position measurement module, a quartz crystal oscillator, an oscillation signal collection module, a speed-sensitive switch, an integration cell, a software processing module, and a sample, wherein the probe is placed perpendicularly, a top end of the probe has a dual-electrode mode of an electrode S1 and an electrode S2, and the quartz crystal oscillator is coated with the sample;
the probe is used for generating an electromagnetic field signal for excitation of micro-region oscillation of the quartz crystal oscillator and receiving an electromagnetic field signal for oscillation attenuation of the quartz crystal oscillator;
the probe moving module is capable of moving in three directions of x, y and z axes;
the optical microscopic measurement module is used for measuring a perpendicular distance between the probe and the quartz crystal oscillator;
the oscillation excitation module is used for sending a high-frequency oscillation signal to excite micro-region oscillation of the quartz crystal oscillator through the probe;
the probe position measurement module is used for measuring dot matrix coordinate information of a position of the probe;
the speed-sensitive switch is used for quickly shutting off an excitation signal of the oscillation excitation module;
the oscillation signal collection module is used for collecting an oscillation amplitude and frequency of the quartz crystal oscillator;
the integration cell is one of a gaseous phase cell, a liquid phase cell, an electrochemistry cell, and a photo-electrochemistry cell, and is used for providing a reaction environment for changes of a micro-mass Δm and viscoelasticity ΔQ of the sample; and
the software processing module is embedded with an envelope fitting equation, an underdamped equation, and a Sauerbrey equation for operation, and obtains Δmxiyj and ΔQxiyj information of an i×j dot matrix, wherein i denotes a quantity of test points in the direction of the x axis, and j denotes a quantity of test lines in the direction of the y axis; and
further performs processing to obtain distribution images of the micro-mass and a dissipation factor of the sample on a surface of the quartz crystal oscillator.

2. The scanning and micro-mass imaging technology using a probe according to claim 1, wherein the oscillation excitation module sends the high-frequency oscillation signal having an identical frequency to a fundamental frequency f0 of the quartz crystal oscillator to the probe; when the probe gradually approaches the quartz crystal oscillator along the z axis, the optical microscopic measurement module displays and measures relative positions of the probe and the quartz crystal oscillator; when the probe makes contact with the quartz crystal oscillator, the probe moving module stops the probe from approaching; meanwhile, the electrode S1 and the electrode S2 at the top end of the probe convert a signal sent by the oscillation excitation module into the electromagnetic field signal for excitation of the micro-region oscillation of the quartz crystal oscillator, and the oscillation signal collection module collects the oscillation amplitude and frequency of the quartz crystal oscillator coated with the sample currently; and the probe position measurement module obtains a current coordinate position (xi, yj); and
after the micro-region oscillation of the quartz crystal oscillator is stable, the speed-sensitive switch quickly shuts off the excitation signal of the oscillation excitation module; and
meanwhile, an oscillation process of the quartz crystal oscillator presents an electromagnetic field signal for underdamped attenuation, the electrode S1 and the electrode S2 at the top end of the probe are used as reception electrodes of an electromagnetic field to receive attenuation signals, the oscillation signal collection module collects the attenuation signals at a sampling rate not lower than 2 times of the fundamental frequency f0, the steps are repeated by moving the probe in x and y planes to obtain the Δmxiyj and ΔQxiyj information of the i×j dot matrix, and the software processing module performs processing to obtain distribution images of micro-mass and viscoelasticity changes of the sample on the surface of the quartz crystal oscillator.

3. The scanning and micro-mass imaging technology using a probe according to claim 1, wherein when the integration cell is the gaseous phase cell, the quartz crystal oscillator coated with the sample is mounted at a bottom of the gaseous phase cell; and the gaseous phase cell is provided with a first connector and a second connector, research gas is guided into the gaseous phase cell through the first connector, the research gas reacts with the sample to cause micro-mass and viscoelasticity changes, and finally the gas is discharged from the second connector.

4. The scanning and micro-mass imaging technology using a probe according to claim 1, wherein when the integration cell is the liquid phase cell, the quartz crystal oscillator coated with the sample is mounted at a bottom of the liquid phase cell; and the liquid phase cell is provided with a first connector and a second connector, liquid is guided into the liquid phase cell through the first connector, the liquid reacts with the sample to cause micro-mass changes, and finally the liquid is discharged from the second connector.

5. The scanning and micro-mass imaging technology using a probe according to claim 1, wherein when the integration cell is the electrochemistry cell a transparent conductive oxide film is deposited on the surface of the quartz crystal oscillator, the quartz crystal oscillator is mounted at a bottom of the electrochemistry cell, and the sample is deposited on the quartz crystal oscillator in advance or deposited on the quartz crystal oscillator in a photo-electrochemistry reaction process; and a three-electrode system is arranged in the electrochemistry cell, and the three-electrode system is connected to an external electrochemistry workstation.

6. The scanning and micro-mass imaging technology using a probe according to claim 1, wherein when the integration cell is the photo-electrochemistry cell, a transparent conductive oxide film is deposited on the surface of the quartz crystal oscillator, the quartz crystal oscillator is mounted at a bottom of the photo-electrochemistry cell, and the sample is deposited on the quartz crystal oscillator in advance or deposited on the quartz crystal oscillator in an electrochemistry reaction process; a three-electrode system is arranged in the electrochemistry cell, and the three-electrode system is connected to an external electrochemistry workstation; and an external spectrum tester emits a light beam that irradiates the sample, and meanwhile, receives and analyzes a light beam reflected/transmitted by the sample.

7. The scanning and micro-mass imaging technology using a probe according to claim 5, wherein a working electrode in the three-electrode system is the quartz crystal oscillator or the sample deposited on the surface of the quartz crystal oscillator; a counter electrode in the three-electrode system is one of electrodes of noble metals such as gold, silver, platinum, palladium and iridium, and alloys of the metals; a reference electrode in the three-electrode system is one of a hydrogen electrode, a calomel electrode, a silver-silver chloride electrode, a mercury-mercuric oxide electrode, and a mercury-mercurous sulfate electrode; and the transparent conductive oxide film is one of an indium tin oxide film, an aluminum-doped zinc oxide film, a fluorine-doped tin oxide film, an antimony-doped tin oxide film, a gallium-doped zinc oxide film, zinc oxide films doped with other elements, and a titanium oxide-based film.

8. The scanning and micro-mass imaging technology using a probe according to claim 1, wherein the electrode S1 and the electrode S2 are coils or metal sheets; and the quartz crystal oscillator is a thin quartz sheet having a piezoelectric property.
